(19) United States
(12) Patent Application Publication
(10) Pub. No.: US 2023/0303096 A1
(43) Pub. Date: Sep. 28, 2023

(54) ADJUSTING DRIVING ASSISTANCE BASED ON QUALITY OF NETWORK

(71) Applicant: Tencent Technology (Shenzhen) Company Limited, Shenzhen (CN)

(72) Inventor: Yixue LEI, Shenzhen (CN)

(73) Assignee: Tencent Technology (Shenzhen) Company Limited, Shenzhen (CN)

(21) Appl. No.: 18/205,371

(22) Filed: Jun. 2, 2023

Related U.S. Application Data
(63) Continuation of application No. PCT/CN2022/133509, filed on Nov. 22, 2022.

(30) Foreign Application Priority Data
Jan. 6, 2022 (CN) 202210010362.3

(51) Int. Cl. B60W 50/029; H04W 24/08; B60W 60/00; B60W 50/00

(52) U.S. Cl. CPC B60W 50/029; H04W 24/08; B60W 60/001; B60W 50/0097; H04W 64/00

(57) ABSTRACT

A network-connected autonomous driving method includes obtaining, by a vehicle, adjustment information corresponding to quality of service (QoS) information of a network to which the vehicle is connected. The QoS information includes a predicted QoS of the network. The method further includes adjusting, by the vehicle, a driving assistance mode or driving control mode of the vehicle according to the adjustment information.

### RELATED APPLICATIONS

This application is a continuation of International Application No. PCT/CN2022/133509, filed on Nov. 22, 2022, which claims priority to Chinese Patent Application No. 202210010362.3, filed on Jan. 6, 2022. The disclosures of the prior applications are hereby incorporated by reference in their entirety.

### FIELD OF THE TECHNOLOGY

This application relates to the field of autonomous driving technologies, including a network-connected autonomous driving method, an electronic device, a server, a storage medium, and a program product.

### BACKGROUND OF THE DISCLOSURE

The network-connected autonomous driving scheme in the related art, as shown in FIG. 1, means that a vehicle has a certain autonomous driving level, but needs a mobile network, such as a 5th Generation (5G) network, for driving assistance or even direct control of a driving situation of the vehicle. Since the network-connected autonomous driving vehicle relies on a mobile network for autonomous driving, quality of service (QoS) characteristics of the current mobile network directly affect the driving situation of the vehicle.

### SUMMARY

Embodiments of this disclosure provide a network-connected autonomous driving method, a device, a computer-readable storage medium, and a computer program product, which can improve the accuracy of autonomous driving of a vehicle.

In an embodiment, a network-connected autonomous driving method includes obtaining, by a vehicle, adjustment information corresponding to quality of service (QoS) information of a network to which the vehicle is connected. The QoS information includes a predicted QoS of the network. The method further includes adjusting, by the vehicle, a driving assistance mode or driving control mode of the vehicle according to the adjustment information.

In an embodiment, a network-connected autonomous driving method includes obtaining, by a server, QoS information of a network connected to a vehicle. The QoS information includes a predicted QoS of the network. The method further includes transmitting, by the server, the QoS information to the vehicle. The QoS information indicates, to the vehicle, adjustment information to adjust a driving assistance mode or driving control mode of the vehicle.

In an embodiment, a network-connected autonomous driving method includes obtaining, by a server, QoS information of a network connected to a vehicle. The QoS information includes a predicted QoS of the network. The method further includes determining, by the server, adjustment information according to the QoS information, and transmitting, from the server, the adjustment information to the vehicle, the adjustment information indicating, to the vehicle, to adjust a driving assistance mode or driving control mode of the vehicle.

The technical solutions provided in the embodiments of this disclosure can bring the following beneficial effects:

In the embodiments of this disclosure, the target server can obtain the QoS information of the target network connected to the vehicle terminal, and transmit the QoS information to the vehicle terminal, and the vehicle terminal determines the adjustment information corresponding to the QoS information, and adjusts the driving assistance behavior or driving control behavior of the vehicle according to the adjustment information. Alternatively, the target server can obtain the QoS information of the target network connected to the vehicle terminal, determine the adjustment information corresponding to the QoS information, and transmit the adjustment information to the vehicle terminal, and the vehicle terminal adjusts the driving assistance behavior or driving control behavior of the vehicle according to the adjustment information. In other words, the adjustment of the vehicle terminal on the driving assistance behavior or driving control behavior of the vehicle relies on the adjustment information, and the adjustment information is determined based on the target network connected to the vehicle terminal, that is, during the adjustment on the driving assistance behavior or driving control behavior of the vehicle, the QoS characteristics of the target network connected to the vehicle terminal are considered, so that the accuracy and efficiency of autonomous driving of the vehicle can be improved.

### BRIEF DESCRIPTION OF THE DRAWINGS

FIG. 1 is a schematic diagram of a network-connected autonomous driving scheme according to an embodiment of this disclosure.

FIG. 2 is a schematic diagram of a QoS prediction mechanism according to an embodiment of this disclosure.

FIG. 3 is a schematic diagram of a 5G communication system according to an embodiment of this disclosure.

FIG. 4 is an interactive flowchart of a network-connected autonomous driving method according to an embodiment of this disclosure.

FIG. 5 is an interactive flowchart of another network-connected autonomous driving method according to an embodiment of this disclosure.

FIG. 6 is a schematic diagram of a vehicle terminal according to an embodiment of this disclosure.

FIG. 7 is a schematic diagram of a server according to an embodiment of this disclosure.

FIG. 8 is a schematic diagram of another server according to an embodiment of this disclosure.

FIG. 9 is a schematic block diagram of an electronic device 900 according to an embodiment of this disclosure.

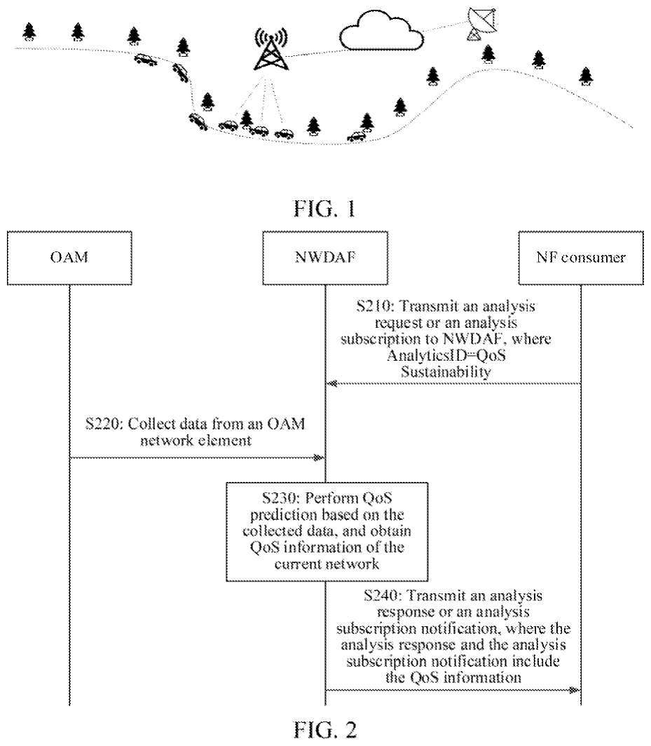

### DESCRIPTION OF EMBODIMENTS

To make the objectives, technical solutions, and advantages of this disclosure clearer, the following further describes implementations of this disclosure in detail with reference to the accompanying drawings.

In the following description, the term “some embodiments” describes subsets of all possible embodiments, but it may be understood that “some embodiments” may be the same subset or different subsets of all the possible embodiments, and can be combined with each other without conflict.

Before the embodiments of this disclosure are introduced, related knowledge of the embodiments of this disclosure is first described.

1. QoS prediction mechanism: The QoS prediction mechanism is a mechanism introduced to a 5G network by the 3rd Generation Partnership Project (3GPP). This mechanism can monitor parameters of different network elements through an NWDAF network element, perform statistical analysis of historical data on QoS characteristics of the 5G network, and predict future trends. FIG. 2 provides a schematic diagram of the QoS prediction mechanism. As shown in FIG. 2, any NF consumer, such as an Application Function (AF), can subscribe to NWDAF to predict QoS, that is, can obtain QoS information of the 5G network. A process of the QoS prediction mechanism is as follows:

S210: An NF consumer can transmit an analysis request (such as Nnwdaf_AnalyticsInfo_Request) or an analysis subscription (such as Nnwdaf_AnalyticsSubscription_Subscribe) to NWDAF, where AnalyticsID=QoS Sustainability).

S220: NWDAF collects data from an Operation And Maintenance (OAM) network element.

S230: NWDAF performs QoS prediction based on the collected data, and obtains QoS information of the current network.

S240: NWDAF transmits an analysis response (such as Nnwdaf_AnalyticsInfo_Response) or an analysis subscription notification (such as Nnwdaf_AnalyticsSubscription_Notify) to the NF consumer, where the analysis response and the analysis subscription notification include the QoS information.

2. Autonomous driving level

L0 autonomous driving level: Pure manual driving. The accelerator, brake, and steering wheel are all controlled by the driver throughout the entire process. The vehicle is only responsible for executing commands without driving intervention. It is the most common driving method, including cruise control, and can only be set at a fixed speed. The vehicle does not automatically adjust the speed such as acceleration/deceleration or operation needs of the driver.

L1 autonomous driving level: Driving control is the main manner, with timely assistance from the system. The vehicle is mainly controlled by the driver, but the system will intervene at specific times. The system is, for example, the Electronic Stability Program (ESP) or the Anti-lock Brake System (ABS), mainly used to improve driving safety.

L2 autonomous driving level: Partially automated, and the driver still needs to focus on the road conditions. If the L1 autopilot is equipped with auxiliary throttle and brakes, the L2 autopilot is added to the steering wheel, and the speed and steering of the vehicle can be controlled under certain conditions. The driver can give up primary control, but still needs to observe the surrounding situation and provide safe operation.

L3 autonomous driving level: Conditional automatic control, the system can automatically control the vehicle in most road conditions, and the driving attention does not need to be focused on the road conditions.

L4 autonomous driving level: Highly automated, and it still has an interface such as a steering wheel to provide real-time driving control. As long as the departure and destination are inputted before departure, in some scenarios, the vehicle can be completely handed over to the autonomous driving system. The system includes, for example, Laser, radar, high-precision map, central processing unit, intelligent road, and traffic facilities.

L5 autonomous driving level: Fully automated, the intelligent system independently completes all driving operations, the autonomous driving vehicle can completely drive the vehicle in any scenario, and human beings completely become passengers.

The technical problem and the technical solutions of this disclosure are described below:

In the related art, a vehicle with a certain autonomous driving level needs to use a mobile network, such as a 5G networks, to provide driving assistance, and even directly control the driving situation of the vehicle. For example, the above L1 to L5 autonomous driving are all network-connected autonomous driving. Since the network-connected autonomous driving vehicle relies on a mobile network for autonomous driving, QoS characteristics of the current mobile network directly affect the driving situation of the vehicle.

In the embodiments of this disclosure, a vehicle terminal can obtain adjustment information corresponding to QoS information of a target network connected to the vehicle terminal, and adjust a driving assistance behavior or driving control behavior of a vehicle according to the adjustment information, thereby improving the accuracy and efficiency of autonomous driving of the vehicle.

The technical solutions of this disclosure can be applied to the following communication system, but is not limited thereto.

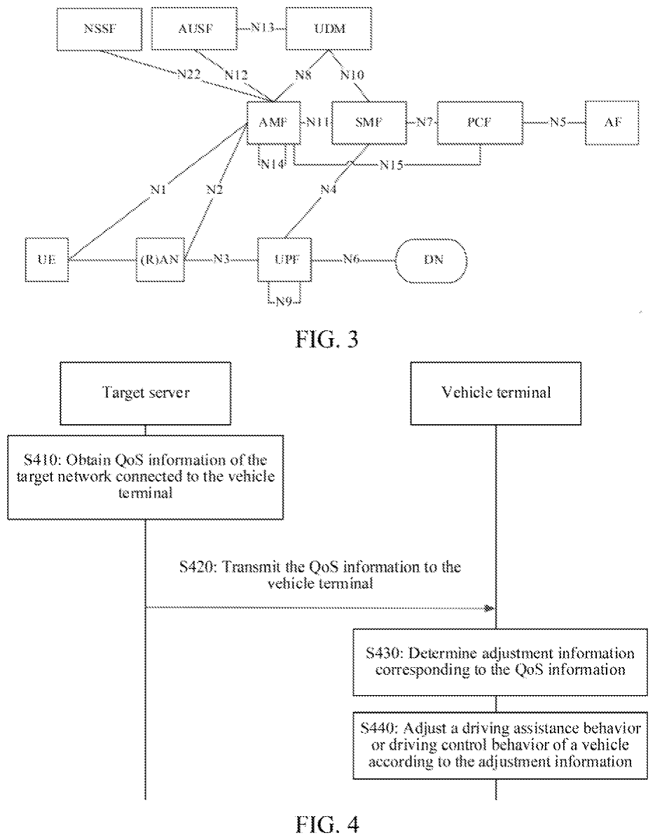

FIG. 3 provides a schematic diagram of a 5G communication system. As shown in FIG. 3, the communication system includes the following network elements:

User Equipment (UE): It may be a mobile phone, a tablet, or a vehicle terminal to be mentioned below, but is not limited thereto.

(Radio) Access Network ((R)AN): It may be a 3GPP access network, such as Long Term Evolution (LTE) or New Radio (NR), or a non-3GPP access network, such as common Wireless Fidelity (WiFi).

User Plane Function (UPF) network element: Its main function is responsible for the routing and forwarding of data packets and QoS flow mapping.

Data Network (DN): For example, operator services, Internet, or third-party services.

Authentication Management Function (AMF) network element: It is the endpoint of a RAN signaling interface, the endpoint of Non-Access Stratum (NAS) signaling, responsible for encryption and security of NAS messages, and responsible for functions such as registration, access, mobility, authentication, and transparent transmission of short messages. In addition, it is also responsible for allocation of EPS bearer identifiers when interacting with an Evolved Packet System (EPS) network.

Session Management Function (SMF) It mainly implements: the endpoint of a session management (SM) message of a NAS message; establishment, modification, release of a session; allocation and management of a UE Internet Protocol (IP) address; Dynamic Host Configuration Protocol function; proxy of Address Resolution Protocol (ARP) or neighbor solicitation proxy of Internet Protocol Version 6 (IPv6); selecting UPF for a session; collection of billing data and support for a billing interface; determining a session and service continuity mode (SSC) of a session; downlink data indication, and so on.

Policy Control Function (PCF) network element: It supports a unified policy framework to manage network behaviors, provides policy rules for network entities to implement, and accesses subscription information in a unified database.

Application Function (AF) network element refers to various services in an application layer, which can be an internal application such as Volte AF of the operator, or a third-party AF (such as video server or game server). If it is an internal AF of the operator, it can directly interact with and access another NF such as PCF in a trusted domain, while the third-party AF is not in the trusted domain, and needs to access the another NF through a Network Exposure Function (NEF).

Unified Data Management (UDM) network element: The main functions responsible are: 1) Generate 3GPP authentication certificate/authentication parameters; 2) Store and manage a permanent user identifier of the 5G system; 3) Subscription information management; 4) Downlink Mobile Terminate (MT)—Service Management System (SMS) submission; 5) SMS management; 6) Registration management of service network elements of a user.

Authentication Server Function (AUSF) network element: It supports authentication for 3GPP access and authentication for untrusted non-3GPP access.

Network Slice Selection Function (NSSF) network element: It is responsible for managing information related to network slices.

In addition, the 5G communication system may further include: Network Data Analytics Function (NWDAF), not shown in FIG. 3, and it is a network analysis logic function managed by the operator, and provides load level analysis.

Artificial Intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning/deep learning.

An autonomous driving technology usually includes technologies such as high-precision maps, environmental perception, behavior decision-making, path planning, and motion control. The autonomous driving technology has broad application prospects.

The solutions provided in the embodiments of this disclosure involve the autonomous driving technology of AI, and are described by the following embodiments.

FIG. 4 is an interactive flowchart of a network-connected autonomous driving method according to an embodiment of this disclosure. Network elements of devices of the method include: a vehicle terminal and a target server. The vehicle terminal is connected to a target network. The target network may be a 5G NR network, a 4G LTE network, or another network, such as WiFi, which is not limited in the embodiments of this disclosure. The target server may be an AF network element in FIG. 3, or another network element, which is not limited in the embodiments of this disclosure. The target server may be an independent physical server, a server cluster including a plurality of physical servers or a distributed system, or a cloud server providing cloud computing services, which is not limited in the embodiments of this disclosure. As shown in FIG. 4, the network-connected autonomous driving method may include:

S410: The target server obtains QoS information of the target network connected to the vehicle terminal.

S420: The target server transmits the QoS information to the vehicle terminal.

S430: The vehicle terminal determines adjustment information corresponding to the QoS information. For example, the vehicle may obtain adjustment information corresponding to quality of service (QoS) information of a network to which the vehicle is connected. The QoS information may include a predicted QoS of the network.

S440: The vehicle terminal adjusts a driving assistance behavior or driving control behavior of a vehicle according to the adjustment information. For example, the vehicle may adjust a driving assistance mode or a driving control mode of the vehicle according to the adjustment information.

In some embodiments, if the vehicle terminal intends to communicate with the target server, the vehicle terminal needs to complete registration on the target server.

In some embodiments, the vehicle terminal may transmit a registration request to the target server, and after obtaining the registration request transmitted by the vehicle terminal, the target server may register the vehicle terminal and generate a registration response, and transmit the registration response to the vehicle terminal to indicate whether the vehicle terminal is successfully registered.

Herein, in some embodiments, after the vehicle terminal is successfully registered, the target server may create a service instance corresponding to the vehicle terminal, that is, the target server creates a corresponding service instance for each successfully registered vehicle terminal. The service instance may obtain a location of the corresponding vehicle terminal (vehicle) and a state of the vehicle in real time, and the state of the vehicle may include at least one of the following: vehicle speed, acceleration, driving direction, traffic flow at the current location, and the like.

In some embodiments, the registration request may include: an identifier of the vehicle terminal, but not limited thereto.

In some embodiments, the identifier of the vehicle terminal may be name, index, or the like of the vehicle terminal, which is not limited in the embodiments of this disclosure.

It is to be understood that when the registration response indicates that the registration of the vehicle terminal fails, the target server may also transmit a cause of the registration failure to the vehicle terminal. For example, the identifier of the vehicle terminal is incorrect or the identifier of the vehicle terminal cannot be recognized. Based on this, the vehicle terminal may modify registration information according to the cause of the registration failure, and perform the registration process again. When the registration response indicates that the vehicle terminal is successfully registered, the vehicle terminal may communicate with the target server.

In some embodiments, it can be seen from the above QoS prediction mechanism that the AF network element may obtain the QoS information of the target network from the NWDAF network element. Based on this, assuming that the target server is an AF network element, the target server may obtain the QoS information of the target network from the NWDAF network element.

In some embodiments, the target server may obtain the location of the vehicle based on the service instance created for the vehicle, and then determine the target network connected to the vehicle based on the location of the vehicle, to obtain the QoS information of the target network; In actual application, after determining the target network connected to the vehicle, the target server may also determine the QoS information of the target network according to the state of the vehicle.

In some embodiments, it can be seen from the above QoS prediction mechanism that the NWDAF network element may collect data from the OAM network element to determine the QoS information of the target network. Based on this, assuming that the target server is an NWDAF network element, the target server may determine the QoS information of the target network according to the collected data.

In other words, the target server may obtain the QoS information of the target network by itself, or obtain the QoS information of the target network from another server or network element, which is not limited in the embodiments of this disclosure.

In some embodiments, the QoS information of the target network includes at least one of the following, but is not limited thereto: transmission bandwidth, transmission delay, and data packet loss rate of the target network.

In some embodiments, the adjustment information may be a control instruction used for adjusting the driving assistance behavior or driving control behavior of the vehicle.

It is to be understood that the driving assistance behavior of the vehicle refers to a driving behavior that relies on auxiliary information provided by the target network, such as: L1 to L4 driving levels, but not limited to thereto. The driving control behavior of the vehicle refers to a driving behavior that completely relies on the target network, such as: L5 driving level, but not limited to thereto.

In some embodiments, there may be a one-to-one correspondence between the adjustment information and the QoS information of the target network, but it is not limited thereto.

In some embodiments, seven preset conditions and seven types of adjustment information corresponding to the QoS information of the target network may be set as follows according to the above division of autonomous driving levels:

When the QoS information of the target network meets a first preset condition, the corresponding adjustment information is to adjust the driving assistance behavior or driving control behavior of the current vehicle, to stop the vehicle from running.

When the QoS information of the target network meets a second preset condition, the corresponding adjustment information is to adjust the driving assistance behavior or driving control behavior of the current vehicle, so that the vehicle adopts L0 autonomous driving.

When the QoS information of the target network meet a third preset condition, the corresponding adjustment information is to adjust the driving assistance behavior or driving control behavior of the current vehicle, so that the vehicle adopts L1 autonomous driving.

When the QoS information of the target network meets a fourth preset condition, the corresponding adjustment information is to adjust the driving assistance behavior or driving control behavior of the current vehicle, so that the vehicle adopts L2 autonomous driving.

When the QoS information of the target network meets a fifth preset condition, the corresponding adjustment information is to adjust the driving assistance behavior or driving control behavior of the current vehicle, so that the vehicle adopts L3 autonomous driving.

When the QoS information of the target network meets a sixth preset condition, the corresponding adjustment information is to adjust the driving assistance behavior or driving control behavior of the current vehicle, so that the vehicle adopts L4 autonomous driving.

When the QoS information of the target network meets a seventh preset condition, the corresponding adjustment information is to adjust the driving assistance behavior or driving control behavior of the current vehicle, so that the vehicle adopts L5 autonomous driving.

In some embodiments, when the QoS information is the transmission bandwidth of the target network, the first preset condition is that the transmission bandwidth of the target network is less than a first transmission bandwidth; the second preset condition is that the transmission bandwidth of the target network is greater than or equal to the first transmission bandwidth and less than a second transmission bandwidth; the third preset condition is that the transmission bandwidth of the target network is greater than or equal to the second transmission bandwidth and less than a third transmission bandwidth; the fourth preset condition is that the transmission bandwidth of the target network is greater than or equal to the third transmission bandwidth and less than a fourth transmission bandwidth; the fifth preset condition is that the transmission bandwidth of the target network is greater than or equal to the fourth transmission bandwidth and less than a fifth transmission bandwidth; the fifth preset condition is that the transmission bandwidth of the target network is greater than or equal to the fifth transmission bandwidth and less than a sixth transmission bandwidth; the sixth preset condition is that the transmission bandwidth of the target network is greater than or equal to the sixth transmission bandwidth and less than a seventh transmission bandwidth; and the seventh preset condition is that the transmission bandwidth of the target network is greater than or equal to a seventh transmission bandwidth.

It is to be understood that the magnitude relationship among the first transmission bandwidth, the second transmission bandwidth, the third transmission bandwidth, the fourth transmission bandwidth, the fifth transmission bandwidth, the sixth transmission bandwidth, and the seventh transmission bandwidth is:

first transmission bandwidth<second transmission bandwidth<third transmission bandwidth<fourth transmission bandwidth<fifth transmission bandwidth<sixth transmission bandwidth<seventh transmission bandwidth.

In some embodiments, when the QoS information is the transmission delay of the target network, the first preset condition is that the transmission delay of the target network is greater than a first transmission delay; the second preset condition is that the transmission delay of the target network is less than or equal to the first transmission delay and greater than a second transmission delay; the third preset condition is that the transmission delay of the target network is less than or equal to the second transmission delay and greater than a third transmission delay; the fourth preset condition is that the transmission delay of the target network is less than or equal to the third transmission delay and greater than a fourth transmission delay; the fifth preset condition is that the transmission delay of the target network is less than or equal to the fourth transmission delay and greater than a fifth transmission delay; the fifth preset condition is that the transmission delay of the target network is less than or equal to the fifth transmission delay and greater than a sixth transmission delay; the sixth preset condition is that the transmission delay of the target network is less than or equal to the sixth transmission delay and greater than a seventh transmission delay; and the seventh preset condition is that the transmission delay of the target network is less than or equal to a seventh transmission delay.

It is to be understood that the magnitude relationship among the first transmission delay, the second transmission delay, the third transmission delay, the fourth transmission delay, the fifth transmission delay, the sixth transmission delay, and the seventh transmission delay is:

first transmission delay>second transmission delay>third transmission delay>fourth transmission delay>fifth transmission delay>sixth transmission delay>seventh transmission delay.

In some embodiments, when the QoS information is the data packet loss rate of the target network, the first preset condition is that the data packet loss rate of the target network is greater than a first data packet loss rate; the second preset condition is that the data packet loss rate of the target network is less than or equal to the first data packet loss rate, and greater than a second data packet loss rate; the third preset condition is that the data packet loss rate of the target network is less than or equal to the second data packet loss rate, and greater than a third data packet loss rate; the fourth preset condition is that the data packet loss rate of the target network is less than or equal to the third data packet loss rate, and greater than a fourth data packet loss rate; the fifth preset condition is that the data packet loss rate of the target network is less than or equal to the fourth data packet loss rate, and greater than a fifth data packet loss rate; the fifth preset condition is that the data packet loss rate of the target network is less than or equal to the fifth data packet loss rate, and greater than a sixth data packet loss rate; the sixth preset condition is that the data packet loss rate of the target network is less than or equal to the sixth data packet loss rate, and greater than a seventh data packet loss rate; and the seventh preset condition is that the data packet loss rate of the target network is less than or equal to a seventh data packet loss rate.

It is to be understood that the magnitude relationship among the first data packet loss rate, the second data packet loss rate, the third data packet loss rate, the fourth data packet loss rate, the fifth data packet loss rate, the sixth data packet loss rate, the seventh data packet loss rate is:

first data packet loss rate>second data packet loss rate>third data packet loss rate>fourth data packet loss rate>fifth data packet loss rate>sixth data packet loss rate>seventh data packet loss rate.

In some embodiments, when the QoS information includes: at least two of the transmission bandwidth, transmission delay, and data packet loss rate of the target network, one with the highest priority can be selected according to priorities of the at least two of the transmission bandwidth, transmission delay, and data packet loss rate of the target network, and the corresponding adjustment information can be determined according to the one with the highest priority. If the one with the highest priority is the transmission bandwidth, transmission delay, or data packet loss rate of the target network, for the corresponding first to seventh preset conditions, reference may be made to the above. This is not described again in the embodiments of this disclosure.

In some embodiments, the priorities of the transmission bandwidth, transmission delay, and data packet loss rate of the target network can be predefined, or configured by a base station, or negotiated between the vehicle terminal and the base station or server. This is not limited in the embodiments of this disclosure.

In some embodiments, the preset conditions and adjustment information corresponding to the QoS information of the target network may not be strictly followed by the above division of autonomous driving levels. For example:

When the QoS information of the target network meets a first preset condition, the corresponding adjustment information is to adjust the driving assistance behavior or driving control behavior of the current vehicle, to stop the vehicle from running.

When the QoS information of the target network meets a second preset condition, the corresponding adjustment information is to adjust the driving assistance behavior or driving control behavior of the current vehicle, so that the vehicle adopts the driving assistance behavior.

When the QoS information of the target network meets a third preset condition, the corresponding adjustment information is to adjust the driving assistance behavior or driving control behavior of the current vehicle, so that the vehicle adopts the driving control behavior.

In some embodiments, when the QoS information is the transmission bandwidth of the target network, the first preset condition is that the transmission bandwidth of the target network is less than a first transmission bandwidth; the second preset condition is that the transmission bandwidth of the target network is greater than or equal to the first transmission bandwidth and less than a second transmission bandwidth; and the third preset condition is that the transmission bandwidth of the target network is greater than or equal to the second transmission bandwidth.

It is to be understood that the magnitude relationship between the first transmission bandwidth and the second transmission bandwidth is: first transmission bandwidth<second transmission bandwidth.

For example, if the vehicle currently adopts the driving assistance behavior, when the transmission bandwidth of the target network is less than the first transmission bandwidth, the adjustment information is used to adjust the driving assistance behavior of the current vehicle, to stop the vehicle from running.

For example, if the vehicle currently adopts the driving control behavior, when the transmission bandwidth of the target network is less than the first transmission bandwidth, the adjustment information is used to adjust the driving control behavior of the current vehicle, to stop the vehicle from running.

For example, if the vehicle currently adopts the driving assistance behavior, when the transmission bandwidth of the target network is greater than or equal to the first transmission bandwidth and less than the second transmission bandwidth, the adjustment information is used to adjust the driving assistance behavior of the current vehicle, so that the vehicle can ensure that the driving assistance behavior remains unchanged, or can be adjusted to any assisted driving level, such as adjusted from L1 to L2, or directly adjusted from L1 to L4, or adjusted from L2 to L1, or directly adjusted from L4 to L2, and so on.

For example, if the vehicle currently adopts the driving control behavior, when the transmission bandwidth of the target network is greater than or equal to the first transmission bandwidth and less than the second transmission bandwidth, then the adjustment information is used to adjust the current vehicle driving control behavior so that the vehicle enters the driving assistance behavior, such as entering any driving level from L1 to L4.

For example, if the vehicle currently adopts the driving assistance behavior, when the transmission bandwidth of the target network is greater than the second transmission bandwidth, the adjustment information is used to indicate to adjust the driving assistance behavior of the current vehicle, so that the vehicle enters the driving control behavior.

For example, if the vehicle currently adopts the driving control behavior, when the transmission bandwidth of the target network is greater than the second transmission bandwidth, the adjustment information is used to maintain the driving control behavior of the current vehicle, or continue to add autonomous driving programs based on the current driving control behavior.

In some embodiments, when the QoS information is the transmission delay of the target network, the first preset condition is that the transmission delay of the target network is greater than a first transmission delay; the second preset condition is that the transmission delay of the target network is less than or equal to the first transmission delay and greater than a second transmission delay; and the third preset condition is that the transmission delay of the target network is less than or equal to the second transmission delay.

It is to be understood that the magnitude relationship between the first transmission delay and the second transmission delay is: first transmission delay>second transmission delay.

For example, if the vehicle currently adopts the driving assistance behavior, when the transmission delay of the target network is greater than the first transmission delay, the adjustment information is used to indicate to adjust the driving assistance behavior of the current vehicle, to stop the vehicle from running.

For example, if the vehicle currently adopts the driving control behavior, when the transmission delay of the target network is greater than the first transmission delay, the adjustment information is used to indicate to adjust the driving control behavior of the current vehicle, to stop the vehicle from running.

For example, if the vehicle currently adopts the driving assistance behavior, when the transmission delay of the target network is less than or equal to the first transmission delay and greater than the second transmission delay, the adjustment information is used to adjust the driving assistance behavior of the current vehicle, so that the vehicle can ensure that the driving assistance behavior remains unchanged, or can be adjusted to any assisted driving level, such as adjusted from L1 to L2, or directly adjusted from L1 to L4, or adjusted from L2 to L1, or directly adjusted from L4 to L2, and so on.

For example, if the vehicle currently adopts the driving control behavior, when the transmission delay of the target network is less than or equal to the first transmission delay and greater than the second transmission delay, the adjustment information is used to adjust the driving control behavior of the current vehicle, so that the vehicle enters the driving assistance behavior, such as entering any driving level from L1 to L4.

For example, if the vehicle currently adopts the driving assistance behavior, when the transmission delay of the target network is less than the second transmission delay, the adjustment information is used to indicate to adjust the driving assistance behavior of the current vehicle, so that the vehicle enters the driving control behavior.

For example, if the vehicle currently adopts the driving control behavior, when the transmission delay of the target network is less than the second transmission delay, the adjustment information is used to maintain the driving control behavior of the current vehicle, or continue to add autonomous driving programs based on the current driving control behavior.

In some embodiments, when the QoS information is the data packet loss rate of the target network, the first preset condition is that the data packet loss rate of the target network is greater than a first data packet loss rate; the second preset condition is that the data packet loss rate of the target network is less than or equal to the first data packet loss rate, and greater than a second data packet loss rate; and the third preset condition is that the data packet loss rate of the target network is less than or equal to the second data packet loss rate.

It is to be understood that the magnitude relationship between the first data packet loss rate and the second data packet loss rate is: first data packet loss rate>second data packet loss rate.

For example, if the vehicle currently adopts the driving assistance behavior, when the data packet loss rate of the target network is greater than the first data packet loss rate, the adjustment information is used to indicate to adjust the driving assistance behavior of the current vehicle, to stop the vehicle from running.

For example, if the vehicle currently adopts the driving control behavior, when the data packet loss rate of the target network is greater than the first data packet loss rate, the adjustment information is used to indicate to adjust the driving control behavior of the current vehicle to stop the vehicle from running.

For example, if the vehicle currently adopts the driving assistance behavior, when the data packet loss rate of the target network is less than or equal to the first data packet loss rate and greater than the second data packet loss rate, the adjustment information is used to adjust the driving assistance behavior of the current vehicle, so that the vehicle can ensure that the driving assistance behavior remains unchanged, or can be adjusted to any assisted driving level, such as adjusted from L1 to L2, or directly adjusted from L1 to L4, or adjusted from L2 to L1, or directly adjusted from L4 to L2, and so on.

For example, if the vehicle currently adopts the driving control behavior, when the data packet loss rate of the target network is less than or equal to the first data packet loss rate and greater than the second data packet loss rate, the adjustment information is used to adjust the driving control behavior of the current vehicle, so that the vehicle enters the driving assistance behavior, such as entering any driving level from L1 to L4.

For example, if the vehicle currently adopts the driving assistance behavior, when the data packet loss rate of the target network is less than the second data packet loss rate, the adjustment information is used to indicate to adjust the driving assistance behavior of the current vehicle, so that the vehicle enters the driving control behavior.

For example, if the vehicle currently adopts the driving control behavior, when the data packet loss rate of the target network is less than the second data packet loss rate, the adjustment information is used to indicate to maintain the driving control behavior of the current vehicle, or continue to add autonomous driving programs based on the current driving control behavior.

In some embodiments, when the QoS information includes: at least two of the transmission bandwidth, transmission delay, and data packet loss rate of the target network, one with the highest priority can be selected according to priorities of the at least two of the transmission bandwidth, transmission delay, and data packet loss rate of the target network, and the corresponding adjustment information can be determined according to the one with the highest priority. If the one with the highest priority is the transmission bandwidth, transmission delay or data packet loss rate of the target network, for the corresponding first to seventh preset conditions, reference may be made to the above. This is not described again in the embodiments of this disclosure.

In some embodiments, the priorities of the transmission bandwidth, transmission delay, and data packet loss rate of the target network can be predefined, or configured by a base station, or negotiated between the vehicle terminal and the base station or server. This is not limited in this disclosure.

To sum up, in the embodiments of this disclosure, the target server can obtain the QoS information of the target network connected to the vehicle terminal, and transmit the QoS information to the vehicle terminal. The vehicle terminal determines the adjustment information corresponding to the QoS information. The vehicle terminal adjusts the driving assistance behavior or driving control behavior of the vehicle according to the adjustment information, that is, the adjustment on the driving assistance behavior or driving control behavior of the vehicle by the vehicle terminal relies on the adjustment information, and the adjustment information is determined based on the target network connected to the vehicle terminal, that is, the driving situation of the vehicle can be controlled according to the QoS characteristics of the target network. For example: if the QoS information of the target network does not meet the corresponding preset conditions, and the vehicle is currently at the L1 autonomous driving level, the vehicle terminal can control the vehicle to stop running, or control the vehicle to rely on the vehicle terminal instead of the target network to drive the vehicle, that is, the vehicle can be adjusted to the L0 autonomous driving level. On the contrary, if the QoS information of the target network meets the corresponding preset conditions, and the vehicle is currently at L1 autonomous driving, the vehicle can be adjusted to any autonomous driving level from L2 to L5. Therefore, the accuracy of autonomous driving of the vehicle can be improved. In addition, the vehicle terminal can obtain the adjustment information corresponding to the QoS information in real time, thereby improving the efficiency of autonomous driving.

FIG. 5 is an interactive flowchart of another network-connected autonomous driving method according to an embodiment of this disclosure. Network elements of devices of the method include: a vehicle terminal and a target server. The vehicle terminal is connected to a target network. The target network may be a 5G NR network, a 4G LTE network, or another network, such as WiFi, which is not limited in this disclosure. The target server may be an AF network element in FIG. 3 or another network element, which is not limited in this disclosure. The target server may be an independent physical server, or a server cluster including a plurality of physical servers or a distributed system, or a cloud server providing cloud computing services, which is not limited in this disclosure. As shown in FIG. 5, the network-connected autonomous driving method may include:

S510: The target server obtains QoS information of the target network connected to the vehicle terminal. For example, the QoS information may include predicted QoS of the network.

S520: The target server determines adjustment information corresponding to the QoS information.

S530: The target server transmits the adjustment information corresponding to the QoS information to the vehicle terminal. For example, the adjustment information may indicate to the vehicle to adjust a driving assistance mode or a driving control mode of the vehicle.

S540: The vehicle terminal adjusts a driving assistance behavior or driving control behavior of a vehicle according to the adjustment information.

The difference between this embodiment and the previous embodiment is: In this embodiment, the adjustment information corresponding to the QoS information is determined by the target server, while in the previous embodiment, the adjustment information corresponding to the QoS information is determined by the vehicle terminal. Based on this, for the description of S510 to S540, reference may be made to the content of the previous embodiment, and details are not described again in the embodiments of this disclosure.

To sum up, in the embodiments of this disclosure, the target server can obtain the QoS information of the target network connected to the vehicle terminal; and determine the adjustment information corresponding to the QoS information, and transmit the adjustment information corresponding to the QoS information to the vehicle terminal. The vehicle terminal controls the vehicle according to the adjustment information, that is, the vehicle terminal can control a driving situation of the vehicle according to QoS characteristics of the target network. Therefore, the accuracy of autonomous driving of the vehicle can be improved. In addition, the vehicle terminal can obtain the adjustment information corresponding to the QoS information in real time, thereby improving the efficiency of autonomous driving.

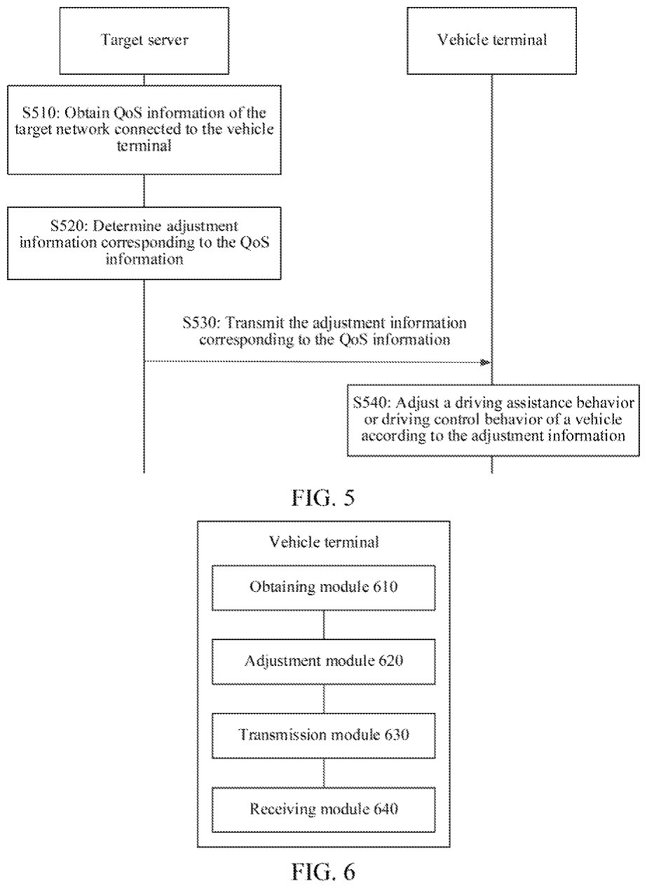

FIG. 6 is a schematic diagram of a vehicle terminal according to an embodiment of this disclosure. As shown in FIG. 6, the vehicle terminal is connected to a target network, and the vehicle terminal includes: an obtaining module 610 and an adjustment module 620, where the obtaining module 610 is configured to obtain adjustment information corresponding to QoS information of the target network; and the adjustment module 620 is configured to adjust a driving assistance behavior or driving control behavior according to the adjustment information.

In some embodiments, the obtaining module 610 is further configured to: obtain QoS information of the target network from a target server; and determine the adjustment information according to the QoS information.

In some embodiments, the obtaining module 610 is further configured to: obtain adjustment information from a target server, where the target server determines the adjustment information according to the QoS information.

The vehicle terminal further includes: a transmission module 630 and a receiving module 640, where before the obtaining module 610 obtains the adjustment information corresponding to the QoS information of the target network, the transmission module 630 is configured to transmit a registration request to the target server; and the receiving module 640 is configured to receive a registration response transmitted by the target server.

In some embodiments, the obtaining module 610 is further configured to obtain location information of the vehicle.

The transmission module 630 is further configured to transmit the location information to the target server,

where the location information is used by the target server to determine the QoS information of the target network based on the location information.

It is to be understood that the device embodiment and the method embodiment may correspond to each other, and for similar descriptions, reference may be made to the method embodiment. To avoid repetition, details are not repeated herein. The device shown in FIG. 6 may perform the method embodiment corresponding to the vehicle terminal corresponding to FIG. 4, and the above and other operations and/or functions of each module in the device are respectively for implementing the method process corresponding to the vehicle terminal in FIG. 4. For brevity, details are not repeated herein.

The device in the embodiments of this disclosure is described above from the perspective of functional modules with reference to the drawings. It is to be understood that the functional modules may be implemented in the form of hardware, or implemented by instructions in the form of software, or implemented by a combination of hardware and software modules. The steps of the method embodiment corresponding to the vehicle terminal in FIG. 4 in the embodiments of this disclosure may be completed by an integrated logic circuit of the hardware in the processor and/or instructions in the form of software. The steps of the method disclosed with reference to the embodiments of this disclosure may be directly performed and completed by using a hardware decoding processor or may be performed and completed by using a combination of hardware and software modules in the decoding processor. In actual application, the software module may be located in a storage medium (non-transitory computer-readable storage medium) that is mature in the art, such as a random access memory, a flash memory, a read-only memory, a programmable read-only memory, an electrically erasable programmable memory, and a register. The storage medium is located in the memory, and the processor (processing circuitry) reads information in the memory and completes the steps of the method embodiment corresponding to the vehicle terminal corresponding to FIG. 4 in combination with hardware thereof.

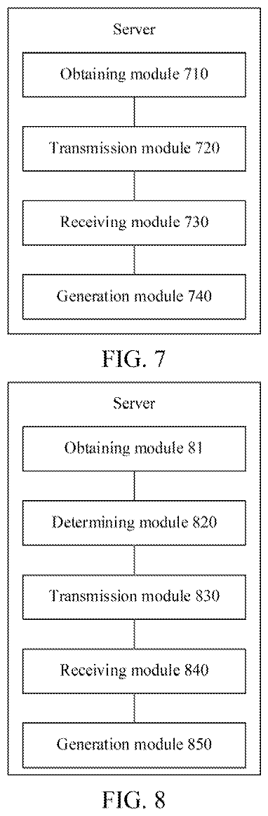

FIG. 7 is a schematic diagram of a server according to an embodiment of this disclosure. As shown in FIG. 7, the server includes: an obtaining module 710 and a transmission module 720, where the obtaining module 71 is configured to obtain QoS information of a target network connected to a vehicle terminal; and the transmission module 720 is configured to transmit the QoS information to the vehicle terminal, so that the vehicle terminal determines adjustment information corresponding to the QoS information, and adjusts a driving assistance behavior or driving control behavior of a vehicle according to the adjustment information.

In some embodiments, the server further includes: a receiving module 730 and a generation module 740, where before the obtaining module 71 obtains the QoS information of the target network connected to the vehicle terminal, the receiving module 730 is configured to receive a registration request transmitted by the vehicle terminal; the generation module 740 is configured to register the vehicle terminal according to the registration request, and generate a registration response; and the transmission module 720 is further configured to transmit the registration response to the vehicle terminal.

In some embodiments, the receiving module 730 is further configured to receive location information of the vehicle transmitted by the vehicle terminal; and

determine the QoS information of the target network connected to the vehicle terminal based on the location information of the vehicle.

It is to be understood that the device embodiment and the method embodiment may correspond to each other, and for similar descriptions, reference may be made to the method embodiment. To avoid repetition, details are not repeated herein. Specifically, the device shown in FIG. 7 may perform the method embodiment corresponding to the server in FIG. 4, and the above and other operations and/or functions of each module in the device are respectively for implementing the method process corresponding to the server in FIG. 4. For brevity, details are not repeated herein.

The device in the embodiments of this disclosure is described above from the perspective of functional modules with reference to the drawings. It is to be understood that the functional modules may be implemented in the form of hardware, or implemented by instructions in the form of software, or implemented by a combination of hardware and software modules. In actual application, the steps of the method embodiment corresponding to the server corresponding to FIG. 4 in the embodiments of this disclosure may be completed by an integrated logic circuit of the hardware in the processor and/or instructions in the form of software. The steps of the method disclosed with reference to the embodiments of this disclosure may be directly performed and completed by using a hardware decoding processor or may be performed and completed by using a combination of hardware and software modules in the decoding processor. In actual application, the software module may be located in a storage medium that is mature in the art, such as a random access memory, a flash memory, a read-only memory, a programmable read-only memory, an electrically erasable programmable memory, and a register. The storage medium is located in the memory, and the processor reads information in the memory, and completes the steps of the method embodiment corresponding to the server corresponding to FIG. 4 in combination with hardware thereof.

FIG. 8 is a schematic diagram of another server according to an embodiment of this disclosure. As shown in FIG. 8, the server includes: an obtaining module 810, a determining module 820, and a transmission module 830, where the obtaining module 810 is configured to obtain QoS information of a target network connected to a vehicle terminal; the determining module 820 is configured to determine adjustment information according to the QoS information; and the transmission module 830 is configured to transmit the adjustment information to the vehicle terminal, so that the vehicle terminal adjusts a driving assistance behavior or driving control behavior of a vehicle according to the adjustment information.

In some embodiments, the server further includes: a receiving module 840 and a generation module 850, where before the obtaining module 810 obtains the QoS information of the target network connected to the vehicle terminal, the receiving module 840 is configured to receive a registration request transmitted by the vehicle terminal; the generation module 850 is configured to register the vehicle terminal according to the registration request, and generate a registration response; and the transmission module 830 is configured to transmit the registration response to the vehicle terminal.

It is to be understood that the device embodiment and the method embodiment may correspond to each other, and for similar descriptions, reference may be made to the method embodiment. To avoid repetition, details are not repeated herein. Specifically, the device shown in FIG. 7 may perform the method embodiment corresponding to the server in FIG. 5, and the above and other operations and/or functions of each module in the device are respectively for implementing the method process corresponding to the server in FIG. 5. For brevity, details are not repeated herein.

The device in the embodiments of this disclosure is described above from the perspective of functional modules with reference to the drawings. It is to be understood that the functional modules may be implemented in the form of hardware, or implemented by instructions in the form of software, or implemented by a combination of hardware and software modules. Specifically, the steps of the method embodiment corresponding to the server corresponding to FIG. 5 in the embodiments of this disclosure may be completed by an integrated logic circuit of the hardware in the processor and/or instructions in the form of software. The steps of the method disclosed with reference to the embodiments of this disclosure may be directly performed and completed by using a hardware decoding processor or may be performed and completed by using a combination of hardware and software modules in the decoding processor. In actual application, the software module may be located in a storage medium that is mature in the art, such as a random access memory, a flash memory, a read-only memory, a programmable read-only memory, an electrically erasable programmable memory, and a register. The storage medium is located in the memory, and the processor reads information in the memory, and completes the steps of the method embodiment corresponding to the server corresponding to FIG. 5 in combination with hardware thereof.

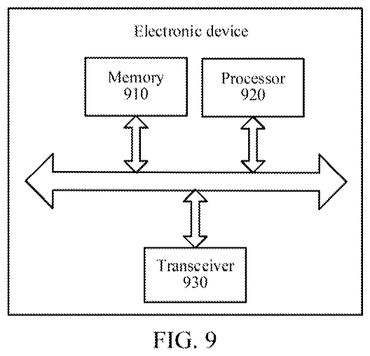

FIG. 9 is a schematic block diagram of an electronic device 900 according to an embodiment of this disclosure. In actual application, the electronic device may be the server or vehicle terminal mentioned in the embodiments of this disclosure.

As shown in FIG. 9, the electronic device 900 may include:

a memory 910 and a processor 920, the memory 910 being configured to store a computer program and transmit the computer program to the processor 920. In other words, the processor 920 may call and run the computer program from the memory 910, to implement the method in the embodiments of this disclosure.

For example, the processor 920 may be configured to perform the above method embodiments according to instructions in the computer program.

In some embodiments of this disclosure, the processor 920 may include, but is not limited to:

a general purpose processor, a digital signal processor (DSP), an application specific integrated circuit (ASIC), a field programmable gate array (FPGA) or other programmable logic devices, discrete gate or transistor logic devices, discrete hardware components, and so on.

In some embodiments of this disclosure, the memory 910 includes, but is not limited to:

a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM) serving as an external cache. Through illustrative but not limited description, RAMs in many forms, for example, a static RAM (SRAM), a Dynamic RAM (DRAM), a synchronous DRAM (SDRAM), a double data rate SDRAM (DDRSDRAM), an enhanced SDRAM (ESDRAM), a synch link DRAM (SLDRAM), and a direct rambus RAM (DRRAM), are available.

In some embodiments of this disclosure, the computer program may be segmented into one or more modules, and the one or more modules are stored in the memory 910 and executed by the processor 920 to complete the method provided in this disclosure. The one or more modules may be a series of computer program instruction segments capable of completing specific functions, and the instruction segments are used to describe the execution process of the computer program in the electronic device.

As shown in FIG. 9, the electronic device may further include:

a transceiver 930, which may be connected to the processor 920 or the memory 910.

The processor 920 may control the transceiver 930 to communicate with other devices, for example, may transmit information or data to other devices, or receive information or data transmitted by other devices. The transceiver 930 may include a transmitter and a receiver. The transceiver 930 may further include an antenna, and one or more antennas may be provided.

It is to be understood that the components in the electronic device are connected through a bus system, where in addition to a data bus, the bus system further includes a power bus, a control bus, and a status signal bus.

This disclosure further provides a computer storage medium, storing a computer program, the computer program, when executed by a computer, causing the computer to perform the methods of the above method embodiments. Alternatively, an embodiment of this disclosure further provides a computer program product including instructions, the instructions, when executed by a computer, causing the computer to perform the methods of the foregoing method embodiments.

When software is used for implementation, implementation may be entirely or partially performed in the form of a computer program product. The computer program product includes one or more computer instructions. When the computer program instructions are loaded and executed on the computer, all or some of the steps are generated according to the process or function described in the embodiments of this disclosure. The computer may be a general purpose computer, a special purpose computer, a computer network, or another programmable device. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber or a digital subscriber line (DSL)) or wireless (for example, infrared, wireless, or microwave) manner. The computer-readable storage medium may be any available medium capable of being accessed by a computer or include one or more data storage devices integrated by an available medium, such as a server and a data center. The available medium may be a magnetic medium (such as a floppy disk, a hard disk, or a magnetic tape), an optical medium (such as a digital video disc (DVD)), a semiconductor medium (such as a solid state disk (SSD)) or the like.

A person of ordinary skill in the art may notice that the exemplary modules and algorithm steps described with reference to the embodiments disclosed in this specification can be implemented in electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but it is not considered that the implementation goes beyond the scope of this disclosure.

In the several embodiments provided in this disclosure, it is to be understood that the disclosed system, device, and method may be implemented in other manners. For example, the device embodiments described above are merely exemplary. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the devices or modules may be implemented in electronic, mechanical, or other forms.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The use of “at least one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof.

The foregoing disclosure includes some exemplary embodiments of this disclosure which are not intended to limit the scope of this disclosure. Other embodiments shall also fall within the scope of this disclosure.

What is claimed is:

1. A network-connected autonomous driving method, comprising: obtaining, by a vehicle, adjustment information corresponding to quality of service (QoS) information of a network to which the vehicle is connected, the QoS information comprising a predicted QoS of the network; and
adjusting, by the vehicle, a driving assistance mode or driving control mode of the vehicle according to the adjustment information.

2. The method according to claim 1, wherein the obtaining the adjustment information comprises:
obtaining the QoS information of the network from a server; and
determining the adjustment information according to the QoS information.

3. The method according to claim 1, wherein
the obtaining the adjustment information comprises:
obtaining the adjustment information corresponding to the QoS information from a server,
wherein the server determines the adjustment information according to the QoS information.

4. The method according to claim 2, wherein the method further comprises:
transmitting, by the vehicle, a registration request to the server; and
receiving, by the vehicle, a registration response transmitted by the server.

5. The method according to claim 4, wherein
the registration response indicates that the vehicle is successfully registered in the server,
the server is an Application Function (AF) network element, and
the server obtains the predicted QoS of the network from a 5G Network Data Analytics Function (NWDAF) network element based on data of the registered vehicle.

6. The method according to claim 2, wherein the method further comprises:
obtaining location information of the vehicle; and
transmitting the location information to the server;
wherein the QoS information of the network is determined by the server based on the location information.

7. The method according to claim 1, wherein the predicted QoS of the network is predicted using 5G Network Data Analytics Function (NWDAF).

8. The method according to claim 1, wherein the adjusting the driving assistance mode or the driving control mode comprises selecting among Level 1-Level 5 of autonomous driving levels.

9. A network-connected autonomous driving method, comprising:
obtaining, by a server, QoS information of a network connected to a vehicle, the QoS information comprising a predicted QoS of the network; and
transmitting, by the server, the QoS information to the vehicle,
wherein the QoS information indicates, to the vehicle, adjustment information to adjust a driving assistance mode or driving control mode of the vehicle.

10. The method according to claim 9, wherein the method further comprises:
receiving, by the server, a registration request transmitted by the vehicle;
registering, by the server, the vehicle according to the registration request, and generating a registration response; and
transmitting, by the server, the registration response to the vehicle.

11. The method according to claim 10, wherein
in response to a successful registration, generating, in the server, a service instance corresponding to the vehicle, the service instance being configured to obtain and store real-time parameters of the vehicle, the real-time parameters comprising at least one of location of the vehicle, vehicle speed, acceleration, driving direction, or traffic flow at current location of the vehicle.

12. The method according to claim 9, wherein the server is an Application Function (AF) network element.

13. The method according to claim 11, wherein the obtaining the QoS information comprises:
receiving, via the service instance of the vehicle in the server, location information of the vehicle; and
determining the QoS information of the network connected to the vehicle based on the location information of the vehicle.

14. The method according to claim 13, wherein the determining the QoS information further comprises:
obtaining, by the server, the predicted QoS of the network from a 5G Network Data Analytics Function (NWDAF) network element based on the location of the vehicle.

15. A network-connected autonomous driving method, comprising:
obtaining, by a server, QoS information of a network connected to a vehicle, the QoS information comprising a predicted QoS of the network;
determining, by the server, adjustment information according to the QoS information; and
transmitting, from the server, the adjustment information to the vehicle, the adjustment information indicating, to the vehicle, to adjust a driving assistance mode or driving control mode of the vehicle.

16. The method according to claim 15, wherein the method further comprises:
receiving, by the server, a registration request transmitted by the vehicle;
registering, by the server, the vehicle according to the registration request, and generating a registration response; and
transmitting, by the server, the registration response to the vehicle.

17. The method according to claim 16, wherein
in response to a successful registration, generating, in the server, a service instance corresponding to the vehicle, the service instance being configured to obtain and store real-time parameters of the vehicle, the real-time parameters comprising at least one of location of the vehicle, vehicle speed, acceleration, driving direction, or traffic flow at current location of the vehicle.

18. The method according to claim 15, wherein the server is an Application Function (AF) network element.

19. The method according to claim 17, wherein the obtaining the QoS information comprises:
receiving, via the service instance of the vehicle in the server, location information of the vehicle; and
determining the QoS information of the network connected to the vehicle based on the location information of the vehicle.

20. The method according to claim 19, wherein the determining the QoS information further comprises:
obtaining, by the server, the predicted QoS of the network from a 5G Network Data Analytics Function (NWDAF) network element based on the location of the vehicle.
